(19) United States
(12) Patent Application Publication
(10) Pub. No.: US 2014/0313761 A1
(43) Pub. Date: Oct. 23, 2014

(54) WHEEL CHAIR LIGHTING

(71) Applicant: Blanche M. Nelson-Herron, Downey, CA (US)

(72) Inventor: Blanche M. Nelson-Herron, Downey, CA (US)

(21) Appl. No.: 13/864,900

(22) Filed: Apr. 17, 2013

(51) Int. Cl. F21V 33/00; F21S 9/03

(52) U.S. Cl. CPC F21V 33/0068; F21S 9/035
USPC 362/523; 362/549; 362/543

(57) ABSTRACT

Provided is device for attaching to a wheelchair. The device provides lighting and makes the wheelchair more visible to motor vehicles.

### BACKGROUND SECTION OF THE INVENTION

Many wheelchair occupants are hit by motor vehicles. The wheelchair occupants have low visibility due to their sitting position. There is a need in the art for devices to increase the visibility of wheelchairs occupants to protect their safety.

### SUMMARY SECTION OF THE INVENTION

Provided is a device for a wheelchair, comprising, a pole having a shaped object attached to thereof in a position that provides visibility while attached to a wheelchair, and lighting around all at least some portion of side of the shape. The lighting can be all around the shape. The shape can be a triangular shape. The light can be visible from both sides of the object. The device can further comprising attaching a beacon light to the pole. The pole can be extendable. The device can further comprise attaching one or more flash lights to the pole. The flash lights can be capable of rotating. The handicap symbol can be lighted. The light can be turned on with a sensor. The device can further comprise a clamp for attaching the pole to the wheelchair. A battery that powers the wheelchair can also provide power to the light. The device can further comprise a motor for rotating the flashlight. The device can further comprise a motor for rotating the object. The device can further comprise a solar panel. The device can further include two or more object extend from the pole at two or more direction. The device can further include two or more objects that are fabricated as a one piece. The device can include three objects that are placed in 120 degree intervals. To each object can be attached thereto a module having light on one side and a solar panel on opposite side.

Provided is a device for a wheelchair, comprising a pole for attaching to a wheelchair, and one or more modules having light therein for attaching to the pole. The module can have lighting on one side and a solar panel on side opposite to the lighting.

### BRIEF DESCRIPTION OF THE FIGURES

FIG. 1 illustrates a flag pole with lighting for attachment to a wheelchair.

FIG. 2 illustrates a flag with the wheel chair symbol acting as a light source.

FIG. 3 illustrates a flag with lights on two sides.

FIG. 4 illustrates a flag with lights on all sides.

FIG. 5 illustrates a flag pole with flash lights.

FIG. 6 illustrates electronic communication between various components.

FIG. 7 illustrates electronic communication between various components.

FIG. 8 illustrates electronic communication between various components.

FIG. 9A illustrates placing modules at edge of shaped objects.

FIG. 9B illustrates attaching modules directly to the pole.

FIG. 10 illustrates a shaped object with grooves for sliding modules.

FIG. 11A illustrates one side of the module with lights.

FIG. 11B illustrates one side of the module with a solar panel.

### DETAILED DESCRIPTION OF THE INVENTION

The present invention provides a device for increasing the visibility of a wheelchair. The device can also provide lighting for a wheelchair occupant so the occupant sees the path in front of the wheelchair. The device may be extendable and rechargeable. Wheelchairs include any personal mobile device with wheels in which a disabled person sits in and travels with. Examples of wheelchairs include wheelchairs that lack electrical components (such as a motor) and motorized electric (scooters) wheelchairs.

The pole (3) is preferably circular and made from concentric segments (3) that can nest in each other. The pole can be made from single piece, or multiple nesting segments, such as about 2 to about 6, with about 3 to 4 being preferred. The pole is preferably about 2 feet to about 6 feet long, such as about 5 feet long. The bottom most segment of the pole can have a diameter (if circular) of about 1 inch. The pole can be made of telescoping chrome steel, high-impact plastic, or fiberglass, or other suitable material. The segments of the pole can all be approximately the same size.

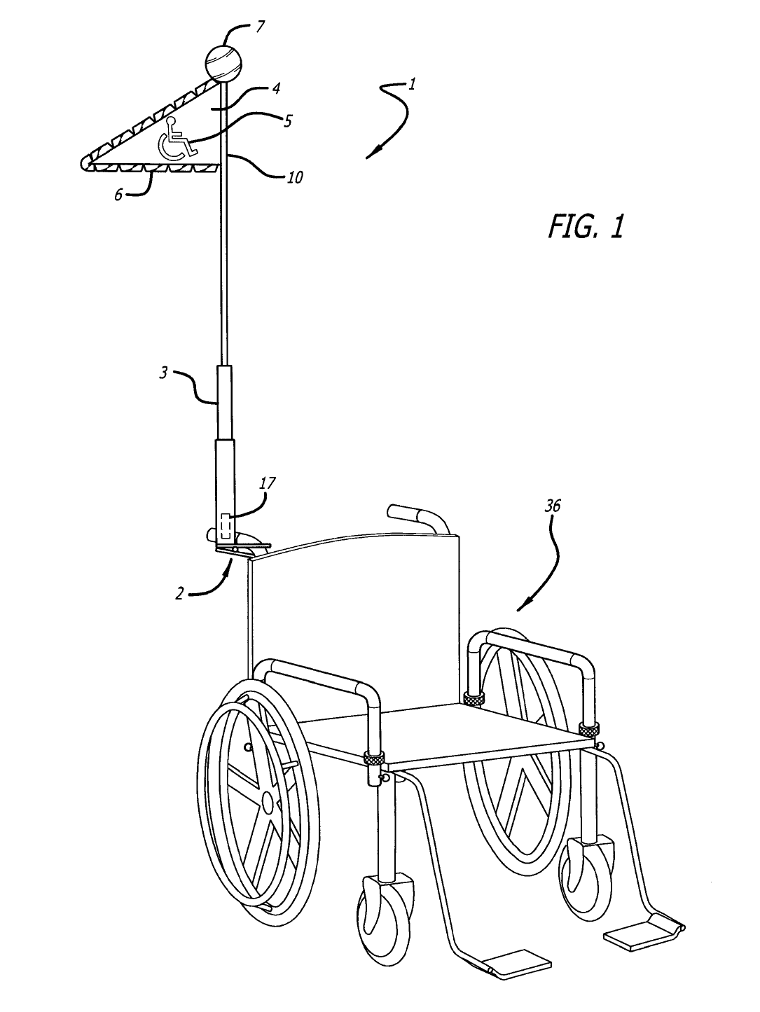

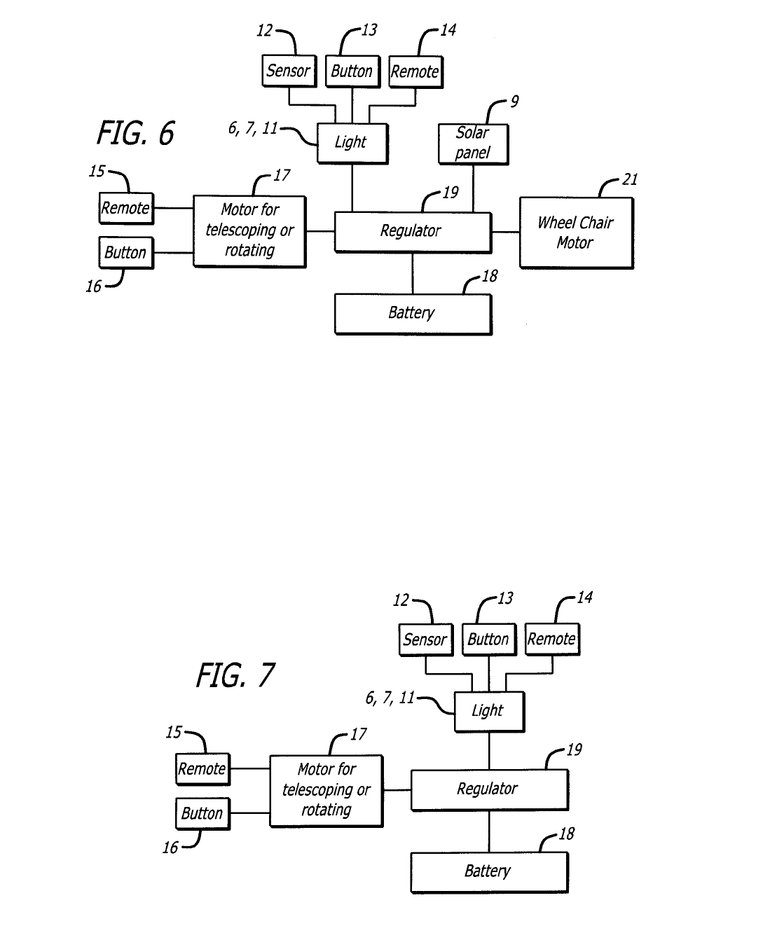

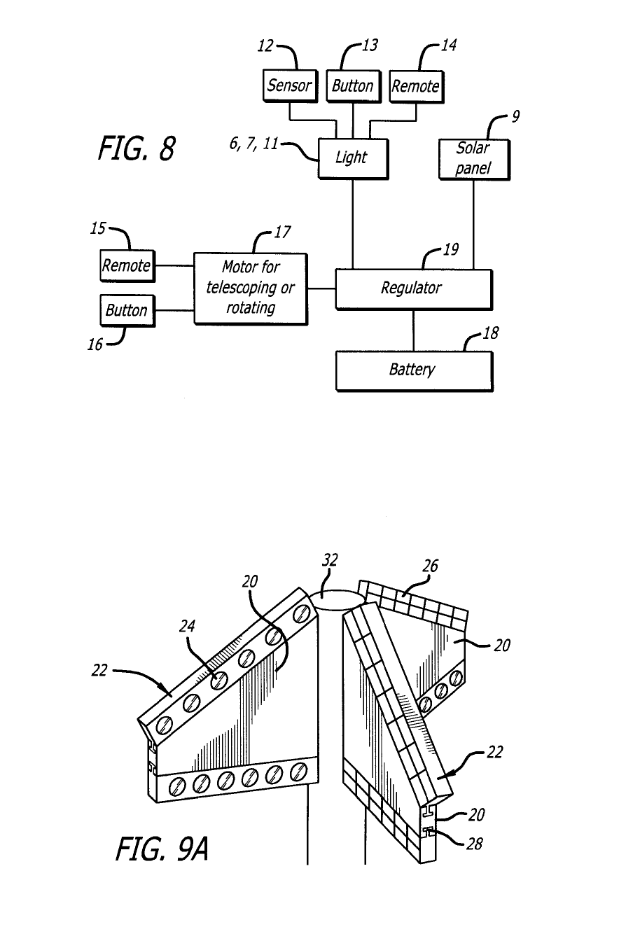

FIG. 1 shows the device in the form of an extendable flag pole (1). The pole can be reversably attached to a wheelchair with a clamp (2). The clamp (2) can be made with a high-impact plastic oversized adjustment screw and a high-impact plastic attachment bracket, multi-axis, grab style. The pole (3) can also be permanently or removably attached to the wheelchair. In one embodiment, the attachment allows for the flag pole to be in electronic communication with the wheelchair's electronics and power system (battery) (FIGS. 6-8). The pole itself can be made from several segments (3) that are retractable and fit into one another. A shaped object (10) is placed on top of the pole. The shaped object can extend out horizontally about 10 to 18 inches, such as about 14 inches. The shaped object can have a vertical length of be about 7 inches to about 15 inches on the side attached to the pole. The shaped object (10) preferably has a thickness of less than about one inch. The shaped object (10) can be made of a fabric, nylon or hard synthetic plastic material. A reflective plasticized canvas flag with white handicap figure on blue background can be used. It is also possible to use other materials like a metal (aluminum) or carbon fiber. The shaped object (10) can have a triangular flag shape (4). Other shapes like rectangle, square and circle can also be used. The flag (4) (or any shape) can have a wheelchair symbol (5) inside of it. In one embodiment, this wheelchair symbol itself is lighted (8). The pole can also have a beacon light (7) or another light placed preferably at top of the pole (3) to provide for additional visibility.

There can be lights on one side, two side (FIG. 3), three (FIG. 4) or all sides of the shaped object. The lights are preferably LED or OLED lights that are attached to the flag (or other shape). The lights can for example be attached by making an opening (holes) in the shaped object (4, 10) and having the lights wrap around the edge of the flag through the openings. The lights can also be attached with a glue or attached to a groove formed at the edge of the shaped object. The light is preferably visible from both sides of the shapes object. In one embodiment, a continuous strip of high intensity lights, preferably blue with an approximate diameter of about ⅜ of an inch is used. In this embodiment, the light is used with a low, high, flashing and off switch located either at base of the pole or through electronic connection to the joystick of the wheelchair. The light can be in a case or module made from high-impact or plastic or fiberglass to attach to pole (3) or the flag itself using for example snap-on-high-impact plastic fiberglass or metal bracket. The light can be connected to the power source at base for example with a USB plug-type connection.

There can be an optional motor (17) either in the wheel chair or in the pole that is functionally connected to one or more of the extending parts of the pole (3), or the flash light (17) or the shaped object (4, 10). The motor (17) can extend and retract the pole (3). The motor (17) can also be used to rotate either the flag (4) or the flashlight (11) to an optimal position. Instead of placing the motor at bottom of the pole or wheelchair (17) , the flashlight (11) or the shaped object can have separate motor(s). Particularly, for the flashlight (11), it can be adjusted so the wheelchair occupant can shine the light where he or she seeks to travel.

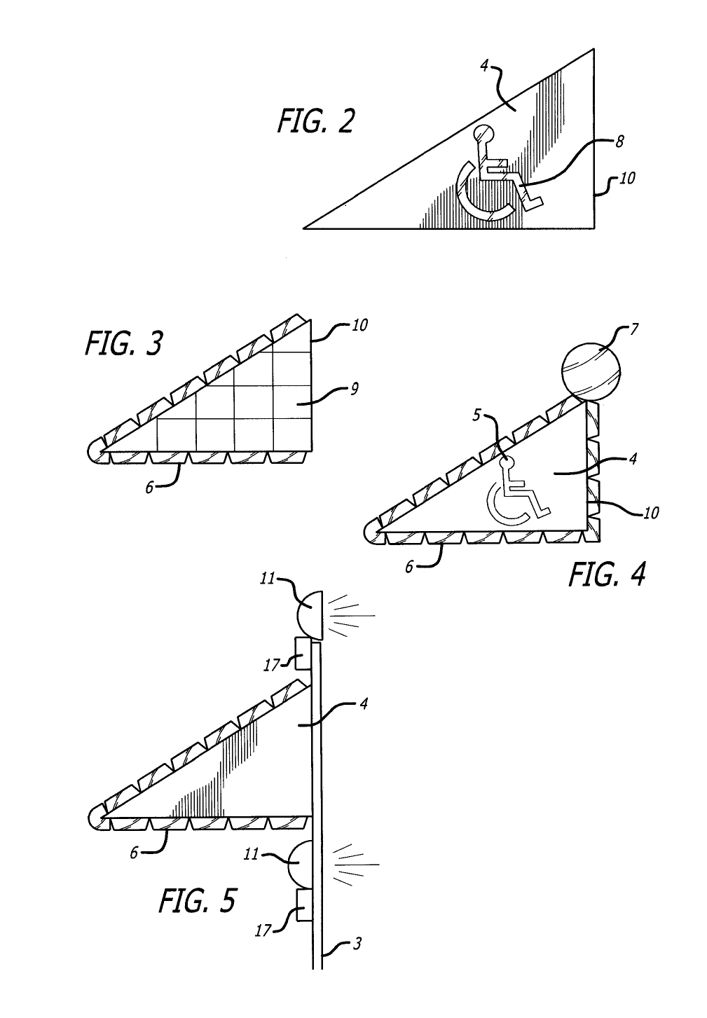

FIG. 2 shows an embodiment where the wheelchair symbol (8) in the flag is the source of light. This embodiment can be combined with embodiment in FIG. 1 with additional lights around the flag, as well as use with other shapes.

FIG. 3 shows the use of a solar panel (9) to power the lights, either directly or by charging a battery. The lights (6) can be directly connected to the solar panel (9). The solar panel can be on one side or both sides of the flag. If the solar panel (9) is on one side, the opposite side can have a wheel chair symbol (5) with or without lighting.

FIG. 4 illustrates the same embodiment as FIG. 1 except the lights (6) go all around the shape, in this case a flag. The optional beacon light (7) is placed at the top.

FIG. 5 illustrates putting a flashlight (11) on the pole (3), such as below or above the flag, or in both places. This flash light (11) directs light in front of the wheelchair so the wheelchair occupant can see where he or she travels.

Any of the lights (6, 7, 11) can be turned on either by a sensor (12) (according to how dark is outside), a button on the wheel chair (12), or a remote control (14). The motor (17) for telescoping or rotating the flag pole or the flashlight (11) can also be remotely controlled (15) or with a button (16) on the wheelchair. A charge/voltage/current regulator (19) can be used to control the current and/or voltage. The battery (18) used to power the lights can be the battery that powers the wheelchair or a separate battery independent of the wheelchair. A solar panel (19) can be used to charge the battery.

In one embodiment, a plurality of shaped objects (2) extend out from the pole (3, 32). A single piece device that is prefabricated can be made with multiple shaped objects (20), 2 or more, preferably 3, as a one piece molded multi-object that is placed over a pole. In case of three objects, there is a shaped object (20) for every 120 degrees, allowing for visibility from all angles. The angles of the objects can be modified to minimize overlap with the wheelchair occupant's head. The prefabricated piece allows for keeping manufacturing costs low and allowing easy assembly with a pole. For example, the 2 or more pieces would be attached to a circular opening that is at the center and the pole would travel through the circular opening.

In another embodiment, one or more of the lights, such as the LED or OLED light (24), is part of a unit or module (22) with a solar panel (26) attached. The solar panel (26) can for example be on one side of the module and the lights (24) on other side of the module. This one piece module (22) can be made to slide against (28) the shaped object (20) for placing the module on one or more sides of the shaped object.

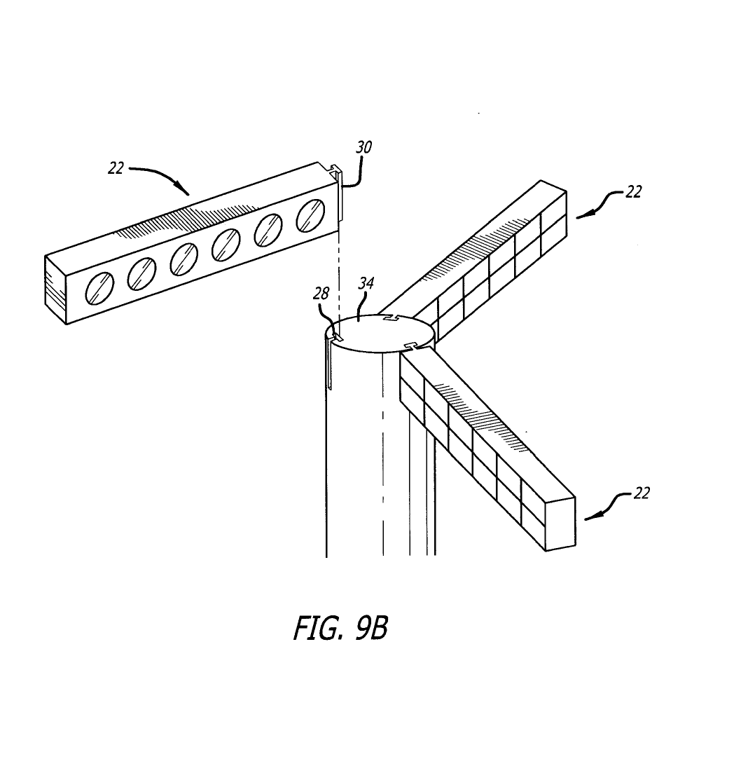

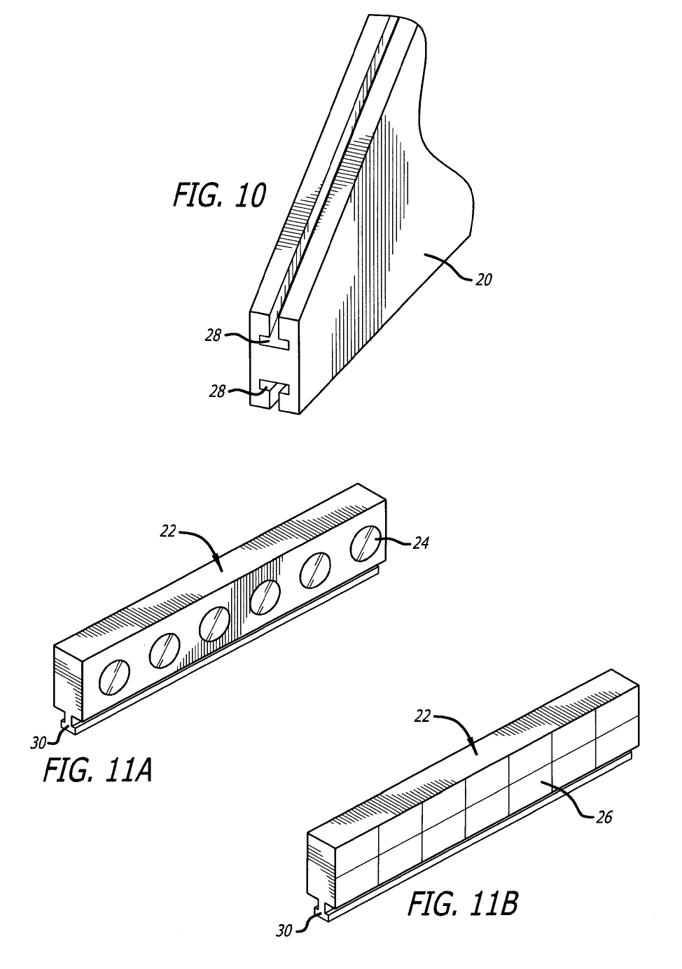

In another embodiment (FIG. 9B), the shaped object is eliminated and the Light module (22) is directly attached to a pole, preferably by sliding the module in place in a groove (28). The module would preferably be removably attached through the shorter side to the pole (30), allowing for module to stick out along its longest side.

In another embodiment, lighting is also provided on the pole itself.

What is claimed is:

1. A device for a wheelchair, comprising:
a. a pole having a shaped object attached to thereof in a position that provides visibility while attached to a wheelchair;
b. lighting around all at least some portion of side of the shape.

2. The device of claim 1, where the lighting is all around the shape.

3. The device of claim 1, wherein the shape in a triangular shape.

4. The device of claim 1, wherein same light is visible from both sides of the object.

5. The device of claim 1, further comprising attaching a beacon light to the pole.

6. The device of claim 1, wherein the pole is extendable.

7. The device of claim 1, further comprising attaching one or more flash lights to the pole.

8. The device of claim 7, wherein the flash lights are capable of rotating.

9. The device of claim 1, wherein the light is turned on with a sensor.

10. The device of claim 1, further comprising a clamp for attaching the pole to the wheelchair.

11. The device of claim 1, wherein a battery that powers the wheelchair also provides power to the light.

12. The device of claim 7, further comprising a motor for rotating the flashlight.

13. The device of claim 1, further comprising a motor for rotating the object.

14. The device of claim 1, further comprising a solar panel.

15. The device of claim 1, wherein two or more object extend from the pole at two or more direction.

16. The device of claim 15, wherein the two or more objects are fabricated as a one piece.

17. The device of claim 16, wherein three objects are placed in 120 degree intervals.

18. The device of claim 15, wherein each object is attached thereto a module having light on one side and a solar panel on opposite side.

19. A device for a wheelchair, comprising:
a. a pole for attaching to a wheelchair,
b. one or more modules having light therein for attaching to the pole.

20. The device of claim 19, wherein the module has lighting on one side and a solar panel on side opposite to the lighting.
